(19) United States
(12) Patent Application Publication
(10) Pub. No.: US 2025/0250433 A1
(43) Pub. Date: Aug. 7, 2025

(54) EPOXY RESIN COMPOSITIONS AND USES THEREOF

(71) Applicant: Westlake Epoxy Inc., Houston, TX (US)

(72) Inventors: Christoph SCHEUER, Dinslaken (DE); Gabriele BADINI, Dusseldorf (DE); Alexander LINZNER, Bottrop (DE); Thomas DRESSEN, Xanten (DE)

(21) Appl. No.: 18/429,620

(22) Filed: Feb. 1, 2024

(51) Int. Cl. C08L 63/00

(52) U.S. Cl. CPC C08L 63/00; C08L 2205/025

(57) ABSTRACT

Embodiments of the present disclosure generally relate to epoxy resin compositions and to uses thereof. In an embodiment, a rotor of an electric motor is provided. The rotor includes a magnet; and an epoxy resin composition disposed over the magnet, the epoxy resin composition comprising: an epoxy resin; a curing agent; a first filler having a loose bulk density of greater than 0.5 g/cm³; and second filler having a loose bulk density of 0.5 g/cm³ or less, the second filler comprising a different filler than the first filler. In an embodiment, an article of manufacture includes a substrate and an epoxy resin composition described herein.

### FIELD

Embodiments of the present disclosure generally relate to epoxy resin compositions and to uses thereof.

### BACKGROUND

During assembly of rotors used for electric motors, magnets are fixed inside rotor steel. Fixation of magnets in rotors is important due to large forces experienced by the magnets during operation as they are subjected to high thermal and mechanical stresses due to high centrifugal forces. Conventional approaches to mechanically reinforce and protect rotors of electric motors include utilizing composite materials that are inserted into air-filled slots of the rotor and structurally bind to components of the rotor. Besides mechanical reinforcement, design concerns of compositions to be used with rotors involve the weight of the composition and its thermal conductivity. For example, because motor efficiency increases with rotational speed of the rotor, it is desired to add minimum additional weight to the rotor in order to combat centrifugal forces. At the same time, as increased power density is sought, the amount of heat to be dissipated also increases, making it important to have proper thermal management in order to improve the reliability, performance, safety, and lifetime of the rotor. Compositions for reinforcing rotors should also withstand high centrifugal forces and thermal stresses observed in rotors.

Conventional approaches have not adequately addressed magnet fixation. For example, state-of-the-art compositions add significant weight to the rotor design. As the weight increases, however, the power decreases. Other state-of-the-art compositions have insufficient thermal conductivity and therefore ineffective thermal management. Ineffective thermal management leads to poor device performance and decreased longevity as the overheating damages materials, generates cracks, and deforms structures in and around the rotor. Safety can also be negatively affected.

Therefore, there is a need for new and improved epoxy resin compositions.

### SUMMARY

Embodiments of the present disclosure generally relate to epoxy resin compositions and to uses of epoxy resin compositions. Embodiments described herein can be used as a fixing resin composition for a rotor and as a fixing resin composition for use in a process for preparing a rotor, among other applications. Unlike conventional technologies for fixing resin compositions, epoxy resin compositions described herein can be lightweight while maintaining good thermal conductivity. When used with a rotor, the lightweight characteristics of epoxy resin compositions of the present disclosure can provide a rotor with lower centrifugal forces, higher speeds, and higher rotor efficiency than rotors encapsulated with conventional compositions.

In an embodiment is provided a rotor of an electric motor. The rotor includes a magnet; and an epoxy resin composition disposed over the magnet, the epoxy resin composition comprising: an epoxy resin; a curing agent; a first filler having a loose bulk density of greater than 0.5 g/cm³; and a second filler having a loose bulk density of 0.5 g/cm³ or less, the second filler comprising a different filler than the first filler, and a total wt % of the first filler and the second filler that is from greater than 0 wt % to less than 50 wt % based on a total wt % of the epoxy resin composition, the total wt % of the epoxy resin composition being 100 wt %.

In another embodiment, an epoxy resin composition is provided. The epoxy resin composition includes an epoxy resin; a curing agent; a first filler having a loose bulk density of greater than 0.5 g/cm³; and a second filler having a loose bulk density of 0.5 g/cm³ or less, the second filler comprising a different filler than the first filler, and a total wt % of the first filler and the second filler that is from greater than 0 wt % to less than 50 wt % based on a total wt % of the epoxy resin composition, the total wt % of the epoxy resin composition being 100 wt %.

In another embodiment, an article is provided. The article includes a metal substrate; a material disposed on the metal substrate, the material comprising: an epoxy resin composition described herein.

### DETAILED DESCRIPTION

Embodiments of the present disclosure generally relate to epoxy resin compositions and to uses of epoxy resin compositions such as articles of manufacture. As described above, epoxy resin compositions can be utilized for magnet fixation among other applications. In contrast to conventional compositions that add significant weight to rotor designs, epoxy resin compositions described herein can be less dense and lighter in weight while maintaining good flexural strength and good thermal conductivity. Relative to state-of-the-art compositions, the less dense and lighter weight compositions described herein are associated with lower centrifugal forces and can enable increased motor efficiency. This density benefit and associated reduction in centrifugal force is especially relevant for PMAR motors because they can operate at higher rpm for the same force, leading to an improvement in efficiency, a reduction in the stress on the resin core material interface, or both. In addition, even with the lower density and the lighter weight, epoxy resin compositions described herein maintain good flexural strength and good thermal conductivity. This indicates that epoxy resin compositions of the present disclosure can resist failure due to mechanical stress and can help aid thermal management of the rotor and structures in and around the rotor.

Embodiments described herein can be used in a variety of applications including electric motors, such as synchronous reluctance motors, permanent magnet assisted reluctance (PMAR) motors, components thereof, among other applications. For example, epoxy resin compositions described herein can be utilized to stabilize rotor core designs used for high reluctance torque electric motors, for example, synchronous reluctance motors and PMAR motors.

As used herein, the term “thermally conductive” refers to the property of a material to transfer or pass thermal energy or heat to another element or itself.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

The use of headings is for purposes of convenience only and does not limit the scope of the present disclosure. Embodiments described herein can be combined with other embodiments.

Embodiments of the present disclosure generally relate to epoxy resin compositions. Epoxy resin compositions of the present disclosure can include an epoxy resin, a curing agent, a first filler, and a second filler. The epoxy resin compositions can further include one or more additives. The total weight percent (total wt %) of the epoxy resin compositions described herein do not exceed 100 wt %. In at least one embodiment, an epoxy resin composition includes an epoxy resin comprising an aromatic epoxy resin; a curing agent; a first filler; and a second filler having a loose bulk-density of less than 0.5 g/cm³.

The compositions can be curable compositions. Curable compositions can be cured by application of a stimulus, for example, a change in temperature.

Epoxy resins include those compounds containing at least one vicinal epoxy group. Epoxy resins can be monomeric or polymeric. The epoxy resin can be saturated or unsaturated, aliphatic, cycloaliphatic, aromatic or heterocyclic and may be substituted. In some examples, the choice of epoxy resin is based on, for example, the UV resistance properties desired. The epoxy resin utilized may be, for example, an epoxy resin or a combination of epoxy resins prepared from an epihalohydrin and a phenol or a phenol type compound, prepared from an epihalohydrin and an amine, prepared from an epihalohydrin and an a carboxylic acid, or prepared from the oxidation of unsaturated compounds.

Suitable epoxy resins useful for embodiments described herein can include aromatic epoxy resins and non-aromatic epoxy resins. The epoxy resins can contain more than one, and in some embodiments, two 1,2-epoxy groups per molecule. In some embodiments, the epoxy resin may be liquid rather than solid. In at least one embodiment, the epoxy resin has an epoxide equivalent weight of about 100 to about 5,000, such as from about 100 to about 2,000, such as from about 100 to 500, as determined by titration methods described in ASTM D1652.

In some embodiments, the epoxy resin can be non-aromatic hydrogenated cyclohexane dimethanol and diglycidyl ethers of hydrogenated Bisphenol A-type epoxy resin, such as hydrogenated bisphenol A-epichlorohydrin epoxy resin, cyclohexane dimethanol diglycidylether, and cycloaliphatic epoxy resin.

In at least one embodiment, the epoxy resins utilized include aromatic epoxy resins such as those resins produced from an epihalohydrin and a phenol or a phenol-type compound. The phenol-type compound includes compounds having an average of more than one aromatic hydroxyl group per molecule. Examples of phenol-type compounds include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (the reaction product of phenols and simple aldehydes, such as formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof.

In some embodiments, the epoxy resin utilized includes those resins produced from an epihalohydrin and bisphenols, halogenated bisphenols, hydrogenated bisphenols, novolac resins, and polyalkylene glycols, or combinations thereof.

In at least one embodiment, the epoxy resin utilized includes those resins produced from an epihalohydrin and resorcinol, catechol, hydroquinone, biphenol, bisphenol A, bisphenol AP (1,1-bis(4-hydroxyphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A, or combinations thereof.

Examples of epoxy resins include epoxy resins of dihydroxy phenols, epoxy resins of biphenols, epoxy resins of bisphenols, epoxy resins of halogenated bisphenols, epoxy resins of alkylated bisphenols, epoxy resins of trisphenols, epoxy resins of phenol-aldehyde novolac resins, epoxy resins of halogenated phenol-aldehyde novolac resins, epoxy resins of alkylated phenol-aldehyde novolac resins, epoxy resins of hydrocarbon-phenol resins, epoxy resins of hydrocarbon-halogenated phenol resins, epoxy resins of hydrocarbon-alkylated phenol resins, or combinations thereof. Illustrative, but non-limiting examples of an epoxy resin include Epikote 1001 epoxy resin (epoxy resin based on bisphenol A), Epikote 1004 epoxy resin (epoxy resin based on bisphenol A), Epikote 1007 epoxy resin (epoxy resin based on bisphenol A), Epikote 1009 epoxy resin (epoxy resin based on bisphenol A) Epon SU8 epoxy resin (epoxidized bisphenol A novolac), Epon 1031 epoxy resin (epoxidized glyoxal-phenol novolac), Epon 1163 epoxy resin (epoxy resin based on tetrabromobisphenol A), Epikote 03243/LV epoxy resin (epoxy resin based on (3,4-epoxycyclohexyl) methyl 3,4-epoxycyclohexylcarboxylate and bisphenol A), Epon 164 epoxy resin (epoxidized o-cresol novolac)—all products commercially available from Westlake Epoxy Inc.

In at least one embodiment, the aromatic epoxy resin is selected from the group consisting of a difunctional bisphenol-A-diglycidyl-ether, a bisphenol-F-diglycidyl-ether, a tetra-glycidyl-methylene-dianiline, an epoxidized tetra-phenylethane, a derivative thereof, and combinations thereof. In some embodiments, the aromatic epoxy resin is derived from bisphenol A, bisphenol F, tetraglycidyl-methylenedianiline, a halogenated bisphenol, a novolac, an ortho-aminophenol, a para-aminophenol, a flourenone bisphenol, a dicyclopentadiene, or combinations thereof.

Other illustrative, but non-limiting, examples of epoxy resins include Epikote 828LVEL epoxy resin (a difunctional bisphenol-A-diglycidyl-ether commercially available from Westlake Epoxy), Epikote 162 epoxy resin (a bisphenol-F-diglycidyl-ether commercially available from Westlake Epoxy), Epikote 158 epoxy resin (a bisphenol-F-diglycidyl-ether commercially available from Westlake Epoxy), Epikote 496 epoxy resin (a tetra-glycidyl-methylene-dianiline commercially available from Westlake Epoxy), Epikote 1031 epoxy resin (an epoxidized tetra-phenylethane commercially available from Westlake Epoxy).

In some embodiments, the epoxy resin is selected to have as high aromatic content as possible. For example, the epoxy resin can include aromatic epoxy resins, such as epoxy resins that include phenols, phenyls, combinations thereof, or other aromatic moieties. The higher aromatic content can provide increased thermal conductivity of the composition.

In at least one embodiment, the aromatic epoxy resin has an aromatic content of about 30 wt % to about 70 wt %, such as from about 40 wt % to about 60 wt %, such as from about 40 wt % to about 55 wt % based on the total weight % of the aromatic epoxy resin, though other values are contemplated. In some embodiments, an aromatic content (wt %) in the aromatic epoxy resin, based on the wt % of the aromatic epoxy resin, can be 30, 35, 40, 45, 50, 55, 60, 65, or 70, or ranges thereof. Each of the foregoing numbers can be preceded by the word “about,” “at least about,” “less than about,” or “more than about,” “greater than about,” and any of the foregoing numbers can be used singly to describe an open-ended range or in combination to describe a close-ended range.

The aromatic content of the aromatic epoxy resin is calculated based on the molar weight of the aromatic structure (C₆H₄=76 g/mol) multiplied by the number of aromatic rings of the aromatic epoxy resin and the result is then divided by the total molecular weight of the aromatic epoxy resin.

A total amount of epoxy resin(s) in epoxy resin compositions described herein can be from about 10 weight percent (wt %) to about 40 wt %, such as from about 15 wt % to about 35 wt %, such as from about 20 wt % to about 30 wt %, such as from about 22 wt % to about 28 wt %, such as from about 22 wt % to about 26 wt % or from about 24 wt % to about 26 wt %, based on a total weight percent of the epoxy resin composition, though other amounts are contemplated. Any of the foregoing numbers can be used singly to describe an open-ended range or in combination to describe a close-ended range.

The total weight percent (total wt %) of the epoxy resin composition is based on the total amount of components present in the epoxy resin composition. The total wt % of the epoxy resin composition is 100 wt %.

Compositions described herein further include a curing agent. The curing agent can be a catalytic curing agent or a non-catalytic curing agent. Combinations or blends, in any suitable proportions, of curing agents can be utilized for compositions described herein.

Suitable curing agents can include, but are not limited to, an imidazole, a substituted imidazole, an imidazole adduct, an imidazole complex (for example, Ni-imidazole complex), a tertiary amine, a quaternary ammonium compound, a quaternary phosphonium compound, a dicyandiamide, a salicylic acid, urea, a urea derivative, a boron trifluoride complex, a boron trichloride complex (for example, boron trichloride alkylalmine complex, an epoxy addition reaction product, a tetraphenylene-boron complex, an amine borate, a metal halide, an amine titanate, a metal acetylacetonate, a naphthenic acid metal salt, an octanoic acid metal salt, other metal salts, metal chelates, or combinations thereof.

Curing agents can include, for example, boron trichloride dimethyloctylamine complex (CAS No. 34762-90-8), oligomeric polyethylenepiperazines, bis-(dimethylaminopropyl)-amino-2-propanol, N,N′-bis-(3-dimethylaminopropyl)urea, N-(2-hydroxypropyl)imidazole, dimethyl-2-(2-aminoethoxy)ethanol, bis(2-dimethylaminoethyl) ether, pentamethyldiethylenetriamine, dimorpholinodiethyl ether, 1,8-diazobicyclo[5.4.0]undec-7-ene (DBU) (CAS No. 6674-22-2, commercially available from BASF), N-methylimidazole (also known as 1-methylimidazole (CAS No. 616-47-7), commercially available from BASF), 1,2-dimethylimidazole, methyl nadic anhydride (also known as methyl-5-norbornene-2,3-dicarboxylic anhydride; CAS No. 25134-21-8, commercially available from Polynt), triethylenediamine, 1,1,3,3-tetra-methylguanidine, tin(IV) chloride, tin octoate, or combinations thereof.

In some examples, the curing agent is anhydride free, acid anhydride free, or combinations thereof. Anhydrides and acid anhydrides can be a concern due to their respiratory-sensitizing effects.

A total amount of curing agent(s) in epoxy resin compositions described herein can be from about 10 wt % to about 40 wt %, such as from about 15 wt % to about 35 wt %, such as from about 20 wt % to about 30 wt %, such as from about 22 wt % to about 28 wt %, such as from about 22 wt % to about 26 wt % or from about 24 wt % to about 28 wt %, based on a total weight percent of the epoxy resin composition, though other amounts are contemplated. Any of the foregoing numbers can be used singly to describe an open-ended range or in combination to describe a close-ended range.

Compositions described herein include a first filler. In contrast to the second filler, the first filler has a loose bulk density of greater than 0.5 g/cm³. In some embodiments, the first filler has a loose bulk density of greater than 0.5 g/cm³, less than about 2 g/cm³, or combinations thereof, such as from 0.5 g/cm³ to about 2 g/cm³, such as from about 0.6 g/cm³ to about 1.8 g/cm³, such as from about 0.8 g/cm³ to about 1.6 g/cm³, such as from about 1 g/cm³ to about 1.4 g/cm³, though other values are contemplated. Any of the foregoing numbers can be used singly to describe an open-ended range or in combination to describe a close-ended range.

Illustrative, but non-limiting, examples of first fillers include silica, wollastonite (CaSiO₃ that may contain small amounts of iron, magnesium, and manganese), quartz, alumina, aluminum nitride (AlN), boron nitride (BN), silicon nitride (SiN), silicon carbide (SIC), beryllium oxide (BeO), or combinations thereof, with each of these materials having a loose bulk density of greater than 0.5 g/cm³. Ceramic materials that have a loose bulk density of greater than 0.5 g/cm³, in general, can be used. Inorganic fillers that have a loose bulk density of greater than 0.5 g/cm³, in general, can be utilized. Other fillers that have a loose bulk density of greater than 0.5 g/cm³ are contemplated.

In at least one embodiment, the first filler includes perlite, quartz, fumed silica, fused silica, crystalline silica, alumina, kaolin, talc, clay, mica, rock wool, wollastonite, glass powder, glass flakes, glass beads, glass fibers, silicon carbide, silicon nitride, aluminum nitride, carbon black, graphite, titanium dioxide, calcium carbonate, calcium sulfate, barium carbonate, magnesium carbonate, magnesium sulfate, barium sulfate, epoxy-silane pre-treated silica, epoxy-silane pre-treated wollastonite, or combinations thereof, with each of these materials having a loose bulk density of greater than 0.5 g/cm³. In at least one embodiment, the first filler is selected from the group consisting of silica, wollastonite, quartz, alumina, aluminum nitride, boron nitride, silicon nitride, silicon carbide, beryllium oxide, epoxy-silane pre-treated silica, epoxy-silane pre-treated wollastonite, and combinations thereof, with each of these materials having a loose bulk density of greater than 0.5 g/cm³.

The first filler can include particles that are coated with a silane, a siloxane, a silicone, an epoxysilane, a methylsiloxane, a methacrylic silane, or a mixture thereof.

In some examples, the first filler can include an epoxy-silane pre-treated material, such as an epoxy-silane pre-treated version of the aforementioned fillers, such as epoxy-silane pre-treated silica, epoxy-silane pre-treated wollastonite, or combinations thereof. Illustrative, but non-limiting, examples of epoxysilane pre-treated silica filler include Millisil W12 EST and Millisil SF 600 EST, both commercially available from Quarzwerke Group. An illustrative, but non-limiting, example of an epoxysilane pre-treated wollastonite filler is Tremin 283-100 EST commercially available from Quarzwerke Group.

Examples of commercially available quartz-type fillers include Sikron SF300, Sikron SF 600, Sikron SF 800, Millisil SF 600 EST, and Amosil FW 600 from Quarzwerke GmbH (50226 Frechen, Germany); and Mikro-Dorsilit 120 from Quarzsande GmbH (4070 Eferding, Austria).

Combinations or blends of fillers, in any suitable proportions, can be utilized for compositions described herein. Such combinations can include more than one type of filler.

The first filler can have a thermal conductivity of 1 W/mK or more (W/mK is Watts conducted per meter thickness, per degree Kelvin), about 100 W/mK or less, or combinations thereof, such as from about 1 W/mK to about 100 W/mK, such as from about 1.5 W/mK to about 50 W/mK, such as from about 2 W/mK to about 30 W/mK, such as from about 3 W/mK to about 15 W/mK, though other values are contemplated. Any of the foregoing numbers can be used singly to describe an open-ended range or in combination to describe a close-ended range.

A total amount of the first filler(s) in epoxy resin compositions described herein can be about 60 wt % or less, about 50 wt % or less, about 49 wt % or less, about 40 wt % or more, about 30 wt % or more, or combinations thereof, such as from about 30 wt % to about 60 wt %, such as from about 35 wt % to about 55 wt %, such as from about 40 wt % to about 49 wt %, such as from about 40 wt % to about 45 wt %, such as from about 41 wt % to about 44 wt %, such as from about 40 wt % to about 42 wt %, based on the total wt % of the epoxy resin composition, though other amounts are contemplated. Any of the foregoing numbers can be used singly to describe an open-ended range or in combination to describe a close-ended range.

Compositions described herein further include one or more second fillers. The second fillers are low density fillers, and have a lower density than that of the first fillers. As used herein, the term “low density” when describing a filler can refer to any suitable filler material that has a loose bulk density, also known as a non-packed density, of 0.5 g/cm³ or less (or 500 kg/m³ or less). The loose bulk density is defined as the mass of an uncompacted sample of the material divided by the volume that the sample occupies. The use of the second filler, having a lower density than the first filler, can enable a manufacturer to reduce the weight of the part (for example, a rotor), while maintaining required mechanical characteristics and durability. Combinations of second fillers can be utilized, in any suitable proportions, if desired.

In some embodiments, a loose bulk density of the second filler is 0.5 g/cm³ or less, greater than 0 g/cm³, or combinations thereof, such as about 0.45 g/cm³ or less, such as about 0.4 g/cm³ or less, such as about 0.35 g/cm³ or less, such as about 0.3 g/cm³ or less, such as about 0.25 g/cm³ or less, such as about 0.2 g/cm³ or less, such as about 0.15 g/cm³ or less, such as about 0.1 g/cm³ or less, though other values are contemplated. Any of the foregoing numbers can be used singly to describe an open-ended range or in combination to describe a close-ended range. In at least one embodiment, the loose bulk density of the second filler is from about 0.1 g/cm³ to about 0.5 g/cm³, such as from about 0.15 g/cm³ to about 0.45 g/cm³, such as from about 0.2 g/cm³ to about 0.4 g/cm³, such as from about 0.25 g/cm³ to about 0.35 g/cm³, such as from about 0.25 g/cm³ to about 0.3 g/cm³ or from about 0.3 g/cm³ to about 0.35 g/cm³, though other values are contemplated. Any of the foregoing numbers can be used singly to describe an open-ended range or in combination to describe a close-ended range.

The second filler can include any suitable material such as perlite, quartz, fumed silica, fused silica, crystalline silica, alumina, kaolin, talc, clay, mica, rock wool, wollastonite, glass powder, glass flakes, glass beads, glass fibers, silicon carbide, silicon nitride, aluminum nitride, carbon black, graphite, titanium dioxide, calcium carbonate, calcium sulfate, barium carbonate, magnesium carbonate, magnesium sulfate, barium sulfate, epoxy-silane pre-treated silica, epoxy-silane pre-treated wollastonite, or combinations thereof, where each of these materials have a loose bulk density of 0.5 g/cm³ or less.

In at least one embodiment, the second filler comprises an inorganic filler such as perlite, fumed silica, silicon oxide, aluminium oxide, iron oxide, titanium dioxide, or combinations thereof, where each of these inorganic fillers have a loose bulk density of 0.5 g/cm³ or less. In some embodiments, the second filler includes aluminosilicates, such as perlites, expanded glass spheres, hollow glass microspheres, such as foamed glass, and expanded clay, where each of these materials have a loose bulk density of 0.5 g/cm³ or less. Non-limiting examples of natural second fillers include mineral foam, pumice, foamed larva, and expanded vermiculite, where each of these natural second fillers have a loose bulk density of 0.5 g/cm³ or less. The second filler can be at least partially hollow, include voids, or combinations thereof. The second filler can include a core-shell particle, where the core is at least partially hollow, has voids, or combinations thereof.

In various embodiments, the second filler comprises an aluminosilicate having a loose bulk density of 0.5 g/cm³ or less, such as perlite, such as closed-cell expanded perlite.

The second filler, having a loose bulk density of 0.5 g/cm³ or less, can include particles that are chemically treated to, for example, increase its hydrophobicity, for instance but without limitation by applying a silane, a siloxane, a silicone coating, or a mixture thereof to the particles where the particles.

Examples of commercially available second fillers include those available from Omya International AG under the tradename Omyasphere such as those of the Omyasphere 300 Series (such as Omyasphere 320 T-FQ and Omyasphere 327 T-FQ), and the Omyasphere 200 Series (such as Omyasphere 235 T-FQ and Omyasphere 212 T-FQ), as well as those available from Cenostar Corp. Inc. such as Censopheres sold under the trade name ES-106 RM3, ES-300 RM3, ES-500 RM3, HAL-106, HAL-500, KZ-106, KZ-300, and KZ-500. Omyasphere low density fillers can include perlite such as closed-cell expanded perlite. Cenosphere low density fillers typically include silica, aluminum, and iron.

In some examples, the second filler can include polydimethylsiloxane coated particles having a loose bulk density of 0.5 g/cm³ or less. Examples of commercially available fumed silica can include Acrosil R202 (polydimethylsiloxane coated fumed silica) commercially available from Palmer Holland.

The second filler can have a thermal conductivity of below 1 W/mK and greater than 0 W/mK, such as from greater than 0 W/mK to about 0.5 W/mK, such as from greater than 0 W/mK to about 0.2 W/mK, such as from greater than 0 W/mK to about 0.1 W/mK, though other values are contemplated. Any of the foregoing numbers can be used singly to describe an open-ended range or in combination to describe a close-ended range.

A total amount of second filler(s) in epoxy resin compositions described herein can be greater than 0 wt %, less than about 22 wt %, or combinations thereof, such as from about 1 wt % to about 20 wt %, such as from about 2 wt % to about 15 wt %, such as from about 3 wt % to about 12 wt %, or from about 1 wt % to about 10 wt %, such as from about 5 wt % to about 10 wt %, such as from about 6 wt % to about 9.5, such as from about 7 wt % to about 9 wt %, such as from about 7.5 wt % to about 8.5 wt % based on the total wt % of the epoxy resin composition, though other amounts are contemplated. Any of the foregoing numbers can be used singly to describe an open-ended range or in combination to describe a close-ended range.

A total amount of the first filler and the second filler in epoxy resin compositions described herein can be about 20 wt % or more, about 30 wt % or more, about 40 wt % or more, about 70 wt % or less, about 60 wt % or less, about 50 wt % or less, or combinations thereof, such as from about 30 wt % to about 60 wt %, such as from about 32 wt % to about 58 wt %, such as from about 34 wt % to about 56 wt %, such as from about 36 wt % to about 54 wt %, such as from about 38 wt % to about 52 wt %, such as from about 40 wt % to 50 wt %, such as from about 41 wt % to about 49 wt %, such as from about 42 wt % to about 48 wt %, such as from about 43 wt % to about 47 wt %, such as from about 44 wt % to about 46 wt %, such as about 45 wt % based on the total wt % of the epoxy resin composition. Any of the foregoing numbers can be used singly to describe an open-ended range or in combination to describe a close-ended range. In some embodiments, the total amount of the first filler and the second filler in epoxy resin compositions described herein is less than about 60 wt %, or less than about 55 wt %, or less than 50 wt % based on the total wt % of the epoxy resin composition.

In some embodiments, a weight ratio of the first filler to the second filler is from about 1:1 to about 30:1, such as from about 2.5:1 to about 20:1, such as from about 3:1 to about 15:1, such as from about 3.5:1 to about 10:1, such as from about 4:1 to about 9:1, such as from about 5:1 to about 7:1, though other values are contemplated. Any of the foregoing numbers can be used singly to describe an open-ended range or in combination to describe a close-ended range.

The combined first filler and the second filler can have a thermal conductivity of about 0.25 W/mK or more (W/mK is Watts conducted per meter thickness, per degree Kelvin), about 5 W/mK or less, or combinations thereof, such as from about 0.25 W/mK to about 5 W/mK, such as from about 0.5 W/mK to about 3 W/mK, such as from about 1 W/mK to about 2.5 W/mK, such as from about 1.5 to about 2 W/mK, though other values are contemplated. Any of the foregoing numbers can be used singly to describe an open-ended range or in combination to describe a close-ended range.

Besides the epoxy resin, the curing agent, the first filler, and the second filler epoxy resin compositions described herein can optionally include additives. Illustrative, but non-limiting, examples of optional additives can include, or are selected from the group consisting of, a viscosity modifier (such as an alcohol or polyol), a block copolymer, an anti-foam agent, an anti-settling agent, an air-release agent, a pigment, an ultraviolet stabilizer (UV stabilizer), or combinations thereof. The additives can be used to aid in processing, to improve fracture toughness, among other uses.

In some embodiments, a total amount of optional additive(s) in the compositions described herein can be from about 0 wt % to about 10 wt %, such as from about 0.01 wt % to about 10 wt %, such as from about 0.1 wt % to about 9 wt %, such as from about 0.5 wt % to about 7 wt %, such as from about 1 wt % to about 5 wt %, such as from about 2 wt % to about 3 wt % based on the total wt % of the composition, though other amounts are contemplated. Any of the foregoing numbers can be used singly to describe an open-ended range or in combination to describe a close-ended range.

Suitable modifiers of the composition include alcohols (also known as monohydric alcohols), polyols (also known as polyhydric alcohols), or combinations thereof. Suitable polyols include, but are not limited to glycols (dihydric alcohols (diols)) which can be derived from ethylene glycol, such as, for example, ethylene glycol, propylene glycol, methyl glycol, trimethylene glycol, neopentyl glycol, diethylene glycol, triethylene glycol, polyethylene glycol, polypropylene glycol, sugar compounds, or combinations thereof. Trivalent or higher valent alcohols can also be used, such as, for example, glycerol, trimethylolpropane, glucose, other sugar compounds, or combinations thereof. Other alcohols and polyols are contemplated. In some examples, compositions described herein include a polyol such as glycols, such as ethylene glycol, propylene glycol, polyethylene glycol, polypropylene glycol, glycerols, a sugar compound, or combinations thereof.

A non-limiting example of a glycol can include Heloxy PF, which is propylene glycol with a weight average molecular weight (Mw) of 400 g/mol and is commercially available from Westlake Epoxy Inc. In at least one embodiment, compositions described herein can include a modifier, wherein the modifier is a polyhydric alcohol.

In some embodiments, a total amount of modifier(s) such as monohydric alcohols, polyhydric alcohols, or combinations thereof in epoxy resin compositions described herein is from about 0 wt % to about 2 wt %, such as from about 0.05 wt % to about 1.95 wt %, such as from about 0.1 wt % to about 1.5 wt %, such as from about 0.2 wt % to about 1 wt %, such as from about 0.25 wt % to about 0.5 wt %, or from greater than 0 wt % to about 2 wt %, or from about 0.5 wt % to about 2 wt %, or from about 0.2 wt % to about 0.4 wt % based on the total wt % of the epoxy resin composition, though other amounts are contemplated. Any of the foregoing numbers can be used singly to describe an open-ended range or in combination to describe a close-ended range.

Suitable block copolymers can include functionalized silicones, silicone-containing block copolymers, and combinations thereof. For example, a block copolymer with silicone and organic blocks (the organic blocks, for example being based on caprolactone or other lactones), such as Genioperl W35 (Wacker Chemie AG, Munich, Germany), can be utilized. The block copolymer can serve to improve fracture toughness.

A total amount of block copolymers in epoxy resin compositions described herein can be from about 0 wt % to about 5 wt %, such as from about 0.5 wt % to about 4 wt %, such as from about 1 wt % to about 3.5 wt %, such as from about 1.5 wt % to about 3 wt %, or from greater than 0 wt % to about 4 wt %, or from about 1.5 wt % to about 2 wt % based on the total wt % of the epoxy resin composition, though other amounts are contemplated. Any of the foregoing numbers can be used singly to describe an open-ended range or in combination to describe a close-ended range.

Anti-settling agents can be utilized in epoxy resin compositions described herein to reduce the settling behavior of various components in the composition. Illustrative, but non-limiting, examples of anti-settling agents include Byk 430, Byk 410, Byk 411, Byk 431, each of which are commercially available from BYK-Chemie GmbH. Combinations of anti-settling agents can be used. A total amount of anti-settling agent(s) in epoxy resin compositions described herein can be from about 0 wt % to about 2 wt %, such as from about 0.05 wt % to about 1.5 wt %, such as from about 0.25 wt % to about 1 wt, such as from about 0.45 wt % to about 0.6 wt %, or from greater than 0 wt % to about 2 wt %, or from greater than 0.1 wt % to about 0.5 wt % based on the total wt % of the epoxy resin composition, though other amounts are contemplated. Any of the foregoing numbers can be used singly to describe an open-ended range or in combination to describe a close-ended range.

Anti-foam agents can be utilized in epoxy resin compositions described herein. Illustrative, but non-limiting, examples of anti-foam agents can include FC-402 (which includes tall oil fatty acids, glycols, and Si-containing materials, and is commercially available from Enterprise Specialty Products); Byk-037 (a volatiles-free, silicone-containing anti-foam agent commercially available from BYK-Chemie GmbH); Surfynol 104H (a multifunctional surfactant commercially available from Evonik Industries AG), or combinations thereof. A total amount of anti-foam agent(s) in epoxy resin compositions described herein can be from about 0 wt % to about 2 wt %, such as from about 0.05 wt % to about 1.5 wt %, such as from about 0.25 wt % to about 1 wt, such as from about 0.45 wt % to about 0.6 wt %, or from greater than 0 wt % to about 2 wt %, or from greater than 0.1 wt % to about 0.5 wt % based on the total wt % of the epoxy resin composition, though other amounts are contemplated. Any of the foregoing numbers can be used singly to describe an open-ended range or in combination to describe a close-ended range.

Air-release agents can be utilized in epoxy resin compositions described herein to reduce the amount of bubbling in the compositions, for example, to remove gaseous impurities. Illustrative, but non-limiting, examples of air-release agents include Silfar S184 available from Wacker Chemie AG; Byk S732, Byk-A 500, Byk-A 50, Byk-A 515, Byk 390, Byk 306, Byk 315, and Byk 356, each of which are commercially available from BYK-Chemic GmbH. Combinations of anti-settling agents can be used. A total amount of air-release agent(s) in epoxy resin compositions described herein can be from about 0 wt % to about 2 wt %, such as from about 0.05 wt % to about 1.5 wt %, such as from about 0.25 wt % to about 1 wt, such as from about 0.45 wt % to about 0.6 wt %, or from greater than 0 wt % to about 2 wt %, or from greater than 0.1 wt % to about 0.5 wt % based on the total wt % of the epoxy resin composition, though other amounts are contemplated. Any of the foregoing numbers can be used singly to describe an open-ended range or in combination to describe a close-ended range.

Pigments can be utilized in epoxy resin compositions described herein. Illustrative, but non-limiting, examples of pigments can include magnesium oxide (commercially available from Sigma Aldrich), iron oxide of various oxidation states (commercially available from Lanxess AG), titanium oxide (commercially available from Sigma Aldrich), aluminum oxide (commercially available from Sigma-Aldrich), titanium dioxide (such as Ti-Pure 901/900 commercially available from Chemours), or combinations thereof. Combinations of pigments can be used. A total amount of pigment(s) in epoxy resin compositions described herein can be from about 0 wt % to about 2 wt %, such as from about 0.05 wt % to about 1.5 wt %, such as from about 0.25 wt % to about 1 wt, such as from about 0.45 wt % to about 0.6 wt %, or from greater than 0 wt % to about 2 wt %, or from greater than 0.1 wt % to about 0.5 wt % based on the total wt % of the epoxy resin composition, though other amounts are contemplated. Any of the foregoing numbers can be used singly to describe an open-ended range or in combination to describe a close-ended range.

Epoxy resin compositions of the present disclosure can have any suitable density. The density (at 20° C.) of the epoxy resin composition is determined by DIN EN ISO 1183-1. This density of the epoxy resin composition is distinct from the loose bulk density of the first filler and the second filler. In some embodiments, a density (at 20° C.) of the epoxy resin composition can be less than about 1.9 g/cm³, about 1.1 g/cm³ or more, or combinations thereof, such as from about 1.1 g/cm³ to about 1.9 g/cm³, such as from about 1.2 g/cm³ to about 1.8 g/cm³, such as from about 1.3 g/cm³ to about 1.7 g/cm³, such as from about 1.4 g/cm³ to about 1.6 g/cm³, such as from about 1.45 g/cm³ to about 1.55 g/cm³, or about 1.44 g/cm³, though other values are contemplated. Any of the foregoing numbers can be used singly to describe an open-ended range or in combination to describe a close-ended range.

Epoxy resin compositions of the present disclosure can have any suitable thermal conductivity. The thermal conductivity (at 23° C.) is determined by ASTM E 1461. In some embodiments, a thermal conductivity (at 23° C.) of the epoxy resin composition can be greater than 0.1 W/mK, less than 3 W/mK, or combinations thereof, such as from about 0.1 W/mK to about 3 W/mK, such as from about 0.2 W/mK to about 1 W/mK, such as from about 0.3 W/mK to about 0.8 W/mK, such as from about 0.35 W/mK to about 0.50 W/mK, though other values are contemplated. Any of the foregoing numbers can be used singly to describe an open-ended range or in combination to describe a close-ended range.

At ambient conditions (for example, room temperature (about 20° C. to about 25° C.)), compositions described herein can be in the form of a fluid, paste, or a viscous substance. If the composition is to be curable, any suitable method can be used for curing the composition.

Embodiments described herein also generally relate to methods of making or forming the compositions. In general, epoxy resin compositions described herein can be made or formed by introducing the components (the epoxy resin, the curing agent, the first filler, the second filler, and optional additives) of the epoxy resin composition to one another and mixing the components in conventional mixing units, such as intimate mixers or extruders, generally at room temperature.

The epoxy resin, the curing agent, the first filler, the second filler, and optional additives can be charged to a vessel and stirred, mixed, or otherwise agitated under mixing conditions effective to form a composition. Mixing conditions can include using a mixing pressure of about 1,000 Pa to about 100,000 Pa, such as from about 2,000 Pa to about 50,000 Pa, such as from about 3,000 Pa to about 15,000 Pa, such as from about 4,000 Pa to about 7,000 Pa, such as about 5,000 Pa, though other pressures are contemplated. Any of the foregoing numbers can be used singly to describe an open-ended range or in combination to describe a close-ended range. Mixing conditions can include elevated temperature if desired. However, if elevated temperatures are used during mixing of the materials, the mixing temperature should be below the temperature at which the curing agent becomes active.

Mixing conditions can include stirring, mixing, agitating, or combinations thereof by using suitable devices such as a mechanical stirrer. Such mixing conditions can include use of suitable devices such as a mechanical stirrer such as an overhead stirrer, a magnetic stirrer (for example, placing a magnetic stir bar in the vessel above a magnetic stirrer), or other suitable devices. For example, a stirrer having a blade or propeller can be rotated by receiving rotational power from a stirring motor to stir the one or more materials at suitable rotation speeds. The stirrer having a blade or propeller can be rotated by receiving rotational power from a stirring motor to stir the one or more materials at suitable rotation speeds, such as from about 50 revolutions per minute (rpm) to about 1,500 rpm, such as from about 75 rpm to about 1,000 rpm, such as from about 100 rpm to about 900 rpm, such as from about 200 rpm to about 800 rpm, such as from about 300 rpm to about 700 rpm, such as from about 400 rpm to about 600 rpm, such as from about 450 rpm to about 550 rpm, such as about 500 rpm. Any of the foregoing numbers can be used singly to describe an open-ended range or in combination to describe a close-ended range. Other rotation speeds are contemplated and can be selected based on the ability to mix the components sufficiently.

Mixing conditions can include utilizing a non-reactive gas, such as N₂, Ar, or combinations thereof. For example, a non-reactive gas can be introduced to one or more of the epoxy resin, the curing agent, the first filler, the second filler, and optional additives to degas various components or otherwise remove unwanted gases such as oxygen from the mixture. Mixing conditions can include mixing for any suitable period, such as from about 1 min to about 48 h, such as from about 5 min to about 24 h, such as from about 30 min to about 10 h, such as from about 1 h to about 5 h, such as from about 2 h to about 3 h, though other periods are contemplated. Any of the foregoing numbers can be used singly to describe an open-ended range or in combination to describe a close-ended range.

At this stage, the epoxy resin composition is formed and can be stored for immediate use, later use, or combinations thereof. In addition, and at this stage, the epoxy resin composition can be a curable composition such that the composition can be cured by application of a stimulus. The curable composition can be in the form of a liquid, paste, or gel. One or more of the materials of the curable composition can be dispersed or suspended, as particles. The curable composition can be a 1K system or a 2K system.

The curable composition can be cured under conditions effective to cure the epoxy resin composition. The selected curing conditions can depend on, for example, the temperature at which the curing agent causes reactions to occur that resulting in coupling, cross-linking, or both, of the epoxy resin among other materials. Such curing conditions can include heating the composition to a temperature that is ambient temperature or higher than ambient temperature, such as from about 30° C. to about 300° C., such as from about 40° C. to about 285° C., such as from about 50° C. to about 275° C., such as from about 75° C. to about 250° C., such as from about 100° C. to about 225° C., such as from about 125° C. to about 200° C., such as from about 150° C. to about 175° C., though other temperatures are contemplated. Any of the foregoing numbers can be used singly to describe an open-ended range or in combination to describe a close-ended range.

Curing conditions can include curing for any suitable amount of time, such as from about 1 min to about 48 h, such as from about 5 min to about 24 h, such as from about 30 min to about 10 h, such as from about 1 h to about 5 h, such as from about 2 h to about 3 h, though other periods are contemplated. Any of the foregoing numbers can be used singly to describe an open-ended range or in combination to describe a close-ended range. Curing can be performed in stages, such as cure cycles. For example, a cure cycle can include curing the composition at a first temperature at a first time; raising the temperature at a selected heating rate to a second temperature; and curing the composition at a second temperature for a second time. As a non-limiting example, the cure cycle can have the following profile: curing at a temperature of about 100° C. to about 150° C. (such as about 120° C.) for a period of about 1 hour to about 3 hours (such as about 2 hours); raising the temperature to about 180° C. to about 200° C. (such as about 190° C.), at a rate of about 1° C./minute to about 10° C./minute (such as about 5° C./minute); and then curing at about 180° C. to about 200° C. (such as about 190° C.) for a period of about 2 hours to about 5 hours (such as about 2.5 hours, about 2.7 hours, or about 3 hours). Other cures or cure cycles are contemplated.

If desired, the curable composition can be introduced to a mold prior to curing. That is, the curable composition can be shaped (for example, molded) into any suitable shape. Depending on the application for which the composition is to be used, corresponding shaping of the mixture that is produced can be carried out. Curing can then take place at a selected temperature or temperature range depending on the temperature at which the curing agent used becomes active. The cured composition may then be positioned on a part, such as a rotor or a component of a rotor.

An epoxy resin composition described herein can include a reaction product of a mixture comprising an epoxy resin, a curing agent, a first filler, a second filler, and optional additives.

Embodiments of the present disclosure also generally relate to uses of epoxy resin compositions described herein such as articles of manufacture. In some embodiments, an article includes a substrate and an epoxy resin composition described herein. In some embodiments, the epoxy resin composition (whether cured or not) can contact, directly or indirectly, a substrate. The composition can be disposed over, encapsulate, or otherwise cover at least a portion of the substrate. The substrate can define one or more components (such as structural components or mechanical components) of an apparatus or component thereof that are exposed to, for example, thermal stress, mechanical stress, or centrifugal forces, among other damaging or degrading forces.

The substrate can be an electric motor, a synchronous reluctance motor, a PMAR motor, a component thereof, form a portion thereof, or combinations thereof, among other substrates. Components of electric motors can include a rotor, a stator, a blade, an electric steel sheet, a grain-oriented sheet, a joint, a panel, one or more portions of an electric motor that carry a mechanical load, among other components.

In some embodiments, the substrate is a metal substrate. Metal substrates can be made from or include suitable materials such as neodymium, neodymium alloy, neodymium iron boron, aluminum, aluminum alloy, nickel, iron, iron alloy, steel, electric steel, titanium, titanium alloy, copper, copper alloy, or combinations thereof, such as steel, electrical steel, or combinations thereof. Additionally, or alternatively, the substrate can be a magnet such as a permanent magnet. Any suitable permanent magnet can be utilized. For example, a neodymium magnet (also referred to as neodymium iron boron (NdFeB) magnet) can be used such as that described in U.S. Pat. No. 9,960,646 entitled “Fixing Resin Composition for Use in Rotor” which is incorporated herein by reference in its entirety to the extent not inconsistent with the present disclosure. Additionally, or alternatively, non-limiting examples of permanent magnets can include samarium cobalt, Alnico magnet (comprising aluminum, nickel, and cobalt), among others. In some embodiments, the substrate comprises a magnet selected from the group consisting of neodymium magnet, samarium cobalt, Alnico magnet, and combinations thereof.

In some embodiments, an article described herein can be made by suitable methods. In at least one embodiment, a method of forming an article comprises: positioning a curable composition in a mold; heating the mold and the curable composition to form a cured composition; and positioning the cured composition on a component of the article to form the article. In some embodiments, heating the mold and the curable composition is performed at a temperature that is from about 100° C. to about 225° C., though other temperatures are contemplated.

In some examples, an epoxy resin composition described herein can be deposited on or coated on a substrate surface by using any suitable technique, such as by dipping, spraying, or immersing, among other techniques. Additionally, or alternatively, the substrate can be placed into a mold and encapsulated with an epoxy resin composition described herein.

In some embodiments, a coupling agent is utilized to aid in adhering an epoxy resin composition described herein to the substrate. In these and other embodiments, a material is disposed on a substrate, the material comprising a coupling agent and an epoxy resin composition. The coupling agent can be disposed on a surface of the substrate and the epoxy resin composition can be disposed on the substrate. The material can be a cured product of the coupling agent and the epoxy resin composition.

In some embodiments, the coupling agent includes a compound or species having a functional group that is reactive towards an epoxide group. Such coupling agents can include a sulfur-containing species. The coupling agent interacts chemically, physically, or both, with one or more functional groups present in an epoxy resin composition described herein. For example, when the coupling agent comprises one or more thiol groups (also known as mercaptan groups), the thiol group can interact with one or more epoxide groups of the epoxy resin composition. In such a way, the thiol group of the coupling agent can promote adherence of the epoxy resin composition to the substrate.

In some embodiments, a non-limiting example of a sulfur-containing species is represented by formula (I):

R¹—SH (I).

The sulfur-containing species represented by formula (I) is a thiol (also known as a mercaptan). R¹ of formula (I) can be an unsubstituted hydrocarbyl or a substituted hydrocarbyl. R¹ of formula (I) can be linear or branched, saturated or unsaturated, cyclic or acyclic, aromatic or not aromatic.

An “unsubstituted hydrocarbyl” refers to a group that consists of hydrogen and carbon atoms only. In some embodiments, R¹ of formula (I) can be a substituted hydrocarbyl. A “substituted hydrocarbyl” refers to an unsubstituted hydrocarbyl in which at least one hydrogen of the unsubstituted hydrocarbyl has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as C(O)R*, C(C)NR*², C(O)OR*, NR*₂, OR*, ScR*, TeR*, PR*₂, AsR*₂, SbR*₂, SR*, SOₓ (where x=2 or 3), BR*₂, SiR*₃, GeR*₃, SnR*₃, PbR*₃, and the like, where R* is, independently, hydrogen or unsubstituted hydrocarbyl, or where at least one heteroatom has been inserted within the unsubstituted hydrocarbyl.

Regarding saturation, R¹ of formula (I) can be fully saturated, partially unsaturated, or fully unsaturated. In some embodiments, R¹ of formula (I) can have any suitable number of carbon atoms, such as from 1 to 400 carbon atoms, such as from 1 to 300 carbon atoms, such as from 1 to 200 carbon atoms, such as from 1 to 100 carbon atoms, such as from 1 to 40 carbon atoms, such as from 1 to 20 carbon atoms, such as from 1 to 10 carbon atoms, such as from 1 to 5 carbon atoms, such as from 1 to 4 carbon atoms, though other values are contemplated. Any of the foregoing numbers can be used singly to describe an open-ended range or in combination to describe a close-ended range. In some embodiments, R¹ of formula (I) can be linear or branched alkyl, linear or branched alkenyl, or aryl.

In some examples, R¹ of formula (I) includes a functional group such as an amine (NR*₂), a carboxylic acid (—COOH), an ester (C(O)R*), or combinations thereof, where R* is, independently, hydrogen or unsubstituted hydrocarbyl, or where at least one heteroatom has been inserted within the unsubstituted hydrocarbyl. Polythiols can be utilized. A polythiol is a sulfur-containing species having more than one thiol group.

Illustrative, but non-limiting, examples of sulfur-containing species that can be used as a coupling agent include: (a) a primary thiol, secondary thiol, or tertiary thiol having from 1 to 20 carbon atoms, such as L-cysteine (CAS No. 52-90-4) or 2-ethylhexyl thioglycolate (2EHTG; CAS No. 7659-86-1); (b) Primary polythiols, secondary polythiols, and tertiary polythiols having from 1 to 20 carbon atoms, such as 1,2,6-hexanetriyl tris(mercaptoacetate) (HTM; CAS No. 19759-80-9); (c) mercaptan-terminated polysulfide polymers such as those known by the Thiokol trade name (from Morton Thiokol; available, for example, from SPI Supplies, or from Toray Fine Chemicals), such as the LP-3, LP-33, LP-980, LP-23, LP-55, LP-56, LP-12, LP-31, LP-32 or LP-2 products; (d) mercaptan-terminated polyoxyalkylenc derivatives such as those under the tradename Gabepro GPM-800 (from Gabriel Performance Products) or under the Capcure brand name (from Cognis), such as the WR-8, LOF, and 3-800 products; (e) polyesters of thiocarboxylic acids, for example pentaerythritol tetramercaptoacetate, trimethylolpropane trimercaptoacetate, glycol dimercaptoacetate, pentaerythritol tetra(3-mercaptopropionate), trimethylolpropane tri(3-mercaptopropionate) or glycol di(3-mercaptopropionate), or esterification products of polyoxyalkylenediols or -triols, ethoxylated trimethylolpropane or polyester diols with thiocarboxylic acids such as thioglycolic acid, 2-mercaptopropionic acid, or 3-mercaptopropionic acid; (f) Other compounds having mercapto groups, such as 2,4,6-trimercapto-1,3,5-triazine, 2,2′-(ethylenedioxy)diethanethiol (triethylene glycol dimercaptan), or ethanedithiol; or combinations thereof. One or more sulfur-containing species can be utilized together, if desired.

In some embodiments, a sulfur-containing coupling agent is disposed on the substrate and the epoxy resin composition is disposed on the coupling agent. The substrate, coupling agent, and epoxy resin composition can then be cured by any suitable method. Curing of the coupling agent, epoxy resin composition, components thereof, or combinations thereof, forms a material that includes the coupling agent, the epoxy resin composition, components thereof, a reaction product thereof, or combinations thereof. The material formed can be in the form of a single layer or multiple layers. The selected curing conditions can depend on, for example, the temperature at which the curing agent of the epoxy resin compositions causes reactions to occur that resulting in coupling, cross-linking, or both, of the epoxy resin among other materials. For example, curing can take place between about room temperature (for example, when amine curing agents are used) and about 90° C. to about 180° C. (for example, when amine curing agents are used), though higher temperatures are contemplated. Additionally or alternatively, the selected curing conditions can depend on, for example, the temperature at which the coupling agent can react with materials present in the epoxy resin composition.

Although the epoxy resin composition is described as being disposed on the coupling agent, various suitable implementations are contemplated. For example, the epoxy resin composition can be disposed on (a) the coupling agent, (b) a reaction product of the coupling agent and one or more elements/materials of the substrate, (c) or both.

By disposing the epoxy resin composition on a substrate, the substrate having the epoxy resin composition disposed thereon can be suitable for exposure to an external environment, such as exposure to, for example, thermal stress, mechanical stress, centrifugal force, among other damaging stresses and forces and other degrading stresses and forces. Such stresses and forces are present in many environments, such as for example, electric motors, such as synchronous reluctance motors and PMAR motors, among other environments.

Epoxy resin compositions described herein can be utilized as a fixing resin composition for a rotor and as a fixing resin composition for use in a process for preparing a rotor, among other applications. Unlike conventional technologies for fixing resin compositions, epoxy resin compositions described herein can be lightweight while maintaining good thermal conductivity. The lightweight characteristics of the epoxy resin composition can provide a rotor with lower centrifugal forces, higher speeds, and higher rotor efficiency than rotors encapsulated with conventional compositions.

The epoxy resin composition (or cured composition or cured product) can contact, directly or indirectly, a rotor or a component of a rotor such as a magnet. The epoxy resin composition (or cured composition or cured product) can be disposed over, encapsulate, or otherwise cover at least a portion of an apparatus, device, or component thereof.

For use in disposing epoxy resin compositions described herein over a magnet of a rotor, a rotor can be prepared by inserting a magnet into a rotor core, filling in at least a portion of the rotor core with an epoxy resin composition of the present disclosure, and then curing the epoxy resin composition.

In some embodiments, a coupling agent such as those described above can be utilized to aid in adhering epoxy resin compositions described herein to a substrate. Use of a coupling agent can improve adhesion of the epoxy resin composition a rotor or component thereof, and thereby can help support the high-speed operation of a rotor.

If desired, compositions described herein can be used for other applications such as for use in the coatings or adhesives industries. The compositions can be used generally for producing composites, adhesives, insulation materials, shaped products, binders, paints, sealants, laminates, among other articles and articles of manufacture. The epoxy resin compositions can be used as casting compositions (reaction compositions), molding compositions (reaction resin compositions), as prepregs, among other applications. The epoxy resin compositions can be used in electrical engineering, for example for sheathing electrical and electronic components such as capacitors, collectors, and resistors.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

Examples of compositions described herein and comparative example compositions were made using various materials set out in the Materials and are described further below. Selected properties of the compositions were measured using Test Methods.

### Materials

Non-limiting epoxy resins used for the example and comparative example compositions included Epikote 828LVEL and Epikote 496. Epikote 828LVEL is a difunctional bisphenol-A-diglycidyl-ether epoxy resin and Epikote 496 is a tetra-glycidyl-methylene-dianiline epoxy resin.

Non-limiting fillers used for the example and comparative example compositions included Millisil W12 EST, Tremin 283-100 EST, Millisil SF 600 EST, Aerosil R202, and Omyasphere 320. Millisil W12 EST is an epoxysilane pre-treated silica filler, Tremin 283-100 EST is an epoxysilane pre-treated wollastonite filler, and Millisil SF 600 EST is an epoxysilane pre-treated silica filler. Millisil W12 EST, Millisil SF 600 EST, and Tremin 283-100 EST, each have a loose bulk density greater than 0.5 g/cm³. Omyasphere 320 (made of closed-cell expanded perlite) and Aerosil R202 (a polydimethylsiloxane coated fumed silica) each have a loose bulk density of 0.5 g/cm³ or less.

Polypropylene glycol (400 g/mol), under the trade name Heloxy PF, was used as an example modifier. Byk 430 was used as an example anti-settling agent. Genioperl W35 was utilized as an example block copolymer modifier.

Non-limiting curative components used for the example and comparative example compositions included: methyl nadic anhydride; 1,8-diazabicyclo[5.4.0]undec-7-ene (DBU); and 1-methylimidazole.

An example additive used for the example and comparative example compositions included Silfar S184 (an air release agent).

### Test Methods

Thermal conductivities (at 23° C.) of epoxy resin compositions were determined according to ASTM E 1461.

Adhesion of the epoxy resin composition to a bar (substrate) made of neodymium iron boron (NdFeB) permanent magnet was determined by a 4-point bending test. Steel bars were also tested as substrates and similar results as described for the NdFEB permanent magnet substrate were determined. The 4-point bending test is a measure of flexural strength (in Megapascals, MPa), and was determined according to ISO 178.

A magnet push-out test was utilized to measure adhesion of the epoxy resin compositions to a disc substrate and was performed as follows. The magnet is encapsulated with the composition compositions first cured at a temperature of 120° C. for 1 hour followed by a post-curing at a temperature of 190° C. for 2 hours. The encapsulated magnet was placed in a mount and pushed out of the mount at 23° C.

Density (at 20° C.) of the epoxy resin compositions was determined by DIN EN ISO 1183-1. This density of the epoxy resin composition is distinct from the loose bulk density of the fillers.

Centrifugal force (in units of Newtons, N) was determined by the equation: F=ρ×ω×(D/2), where p is the mass of the unit volume of the composition/substrate in units of kg/m³, ω is the angular velocity of rotation in units of 1/s, and D is the diameter of the disc.

### Example Compositions

Example compositions and comparative example compositions were prepared using the components shown in Table 1. The amounts shown in Table 1 are in units of weight percent unless indicated otherwise. Selected properties of the compositions are also shown in Table 1. In Table 1, “Ex.” refers to an example of the present disclosure, and “C.Ex.” refers to a comparative example. In Table 1, “additives” refer to an additive package that includes Silfar S184 (an air release agent).

The composition of Example 1 includes a first filler as Millisil SF 600 EST, and second fillers as Aerosil R202 Omyasphere 320. Millisil SF 600 EST has a loose bulk density greater than 0.5 g/cm³, while Aerosil R202 and Omyasphere 320 each have a loose bulk density of 0.5 g/cm³ or less. C.Ex. 1 and C.Ex. 2, in contrast, do not include second fillers (those fillers having loose bulk density of 0.5 g/cm³ or less). C.Ex. 1 and C.Ex. 2 include only first fillers which are fillers that have a loose bulk density of greater than 0.5 g/cm³.

The example epoxy resin compositions were made according to the following non-limiting procedure. Prior to blending the materials, the epoxy resins, the first fillers, and the second filler were individually heated at a temperature of about 70° C. for about 2 hours. Following removal of the heat (so that the curing agent does not react), the epoxy resins, the first fillers, the second filler, and the curing agents were then charged into a vessel and mixed at about 500 revolutions per minute (rpm) to about 1,000 rpm and at a pressure of about 50 mbar (˜5,000 Pa). The compositions were delivered into individual molds, and the compositions were cured in the mold using a time and temperature profile which results in full cure or sufficient cure to release the cure composition from the mold after the cure cycle. In these examples, the following cure profile was used: hold at about 100° C. for about 2 hours, ramp to about 190° C. and cure at about 190° C. for about 3 hours. The cured compositions were allowed to cool to room temperature. The cured compositions were then removed from the molds.

TABLE 1

| | Ex. 1 | C. Ex. 1 | C. Ex. 2 |
|---|---|---|---|
| Resin components | | | |
| Epikote 828LVEL, wt % | 17.7 | 13.0 | 11.44 |
| Epikote 496, wt % | 6.05 | 4.4 | 3.89 |
| Polypropylene glycol, wt % | 0.31 | 0.2 | 0.23 |
| Millisil W12 EST, wt % | — | 2.4 | 4.03 |
| Tremin 283-100 EST, wt % | — | 25.7 | 26.18 |
| Millisil SF 600 EST, wt % | 18.16 | — | — |
| Omyasphere 320, wt % | 3.77 | — | — |
| Aerosil R202, wt % | 0.7 | — | — |
| Byk 430; wt % | 0.47 | — | — |
| Total of resin components, wt % | 47.2 | 45.8 | 45.8 |
| Curative components | | | |
| Methyl nadic anhydride, wt % | 24.6 | 18.3 | 16.96 |
| 1-methylimidazole, wt % | 0.06 | 0.1 | 0.04 |
| DBU, wt % | 0.06 | 0.1 | 0.04 |
| Millisil W12 EST, wt % | — | 2.5 | — |
| Tremin 283-100 EST, wt % | — | 31.7 | 35.57 |
| Millisil SF 600 EST, wt % | 20.34 | — | — |
| Omyasphere 320, wt % | 4.23 | — | — |
| Aerosil R202, wt % | 0.79 | — | — |
| Byk 430; wt % | 0.53 | — | 0.18 |
| Additives, wt % | 0.22 | 0.2 | 0.17 |
| Genioperl W35, wt % | 1.97 | 1.5 | 1.34 |
| Total of curative components, wt % | 52.8 | 54.2 | 54.3 |
| Total of resin and curative components, wt % | 100.0 | 100.0 | 100.1 |
| Total of first filler and second filler | 48 | 62.3 | 66 |
| Properties | | | |
| Thermal conductivity (23° C.), W/mK | 0.38 | 0.54 | 0.74 |
| 4-point bending test (23° C.), MPa | 67 | 70 | 68 |
| Magnet push-out test (23° C.), MPa | 12 | 14.5 | 15.6 |
| Density (20° C.), g/cm³ | 1.44 | 1.90 | 1.94 |
| Centrifugal force, N | 78,115 | — | 106,013 |
| Revolutions per minute, rpm | 18,640 | — | 16,000 |

Overall, the data for the composition of Example I indicates that, with a total filler load mass of about 48 wt % resulting in a density of about 1.44 g/cm³, a thermal conductivity of about 0.38 W/mK can be achieved. Here, the composition of Example 1 includes closed-cell expanded perlite as an example second filler (a filler having a loose bulk density of less than 0.5 g/cm³) which leads to the significantly lower density.

The significantly lower density and lighter weight composition of Example 1 is associated with lower centrifugal forces. For example, it was determined that the centrifugal force of the Example 1 composition (about 78,115 N) was significantly lower than that of Comparative Example 2 composition (106,013 N), representing a significant reduction in centrifugal force of about 25%. This density benefit and associated reduction in centrifugal force is especially relevant for PMAR motors because they can operate at higher rpm for the same force, leading to an improvement in efficiency, a reduction in the stress on the resin core material interface, or both. The thermal conductivity data illustrates that epoxy resin compositions of the present disclosure can be utilized for thermal management of heat-generating elements. By contacting (either directly or indirectly) an epoxy resin composition described herein with the heat-generating device, a heat-generating apparatus, or a component thereof, the composition can be utilized to keep temperature-sensitive elements within a prescribed operating temperature in order to avoid failure.

In addition, the flexural strength of the Example 1 composition on the substrate was comparable to the flexural strength of both Comparative Examples 1 and 2 on the substrates, even with a significantly lower loading of fillers. For example, the composition of Example 1 was determined to have a flexural strength of about 67 MPa with a total loading of first filler and second filler of about 48 wt %. The compositions of Comparative Examples 1 and 2, having much higher loadings of filler at about 62 wt % and 66 wt %, were determined to have a flexural strength on the substrate of 68 MPa and 70 MPa, respectively. The magnet push-out test also indicated that adhesion of the Example 1 composition on the substrate was comparable to the adhesion of both Comparative Examples 1 and 2 on the substrates, even with a significantly lower loading of fillers. For example, Example 1 was determined to have a strength of about 12 MPa on the substrate. The Comparative Examples 1 and 2, having significantly higher loadings of filler at about 62 wt % and 66 wt %, were determined to have a strength on the substrate of 14.5 MPa and 15.6 MPa, respectively.

It was also determined that compositions described herein disposed on the substrate can achieve higher revolutions per minute (rpm) than state-of-the-art technologies. For example, the epoxy resin composition of Example 1 on the substrate showed a significantly higher value for rpm relative to the composition of Comparative Example 2 on the substrate compare about 106,019 rpm (Example 1) to 78,115 rpm (Comparative Example 2). Such data indicates that epoxy resin compositions of the present disclosure can have significantly higher power density than conventional technologies. Overall, the examples demonstrate that epoxy resin compositions of the present disclosure can be utilized as a low-density encapsulation system for magnet fixation in a rotor.

Embodiments described herein generally relate to epoxy resin compositions and to uses of epoxy resin compositions such as articles of manufacture. Epoxy resin compositions can be utilized for magnet fixation among other applications. In contrast to conventional compositions that add significant weight to rotor designs, epoxy resin compositions described herein can be lightweight while maintaining good thermal conductivity. Relative to state-of-the-art compositions, the lighter weight compositions described herein can enable increased motor efficiency. The improved thermal conductivity of epoxy resin compositions described herein can help aid thermal management of the rotor and structures in and around the rotor.

As used herein, reference to an R group, alkyl, substituted alkyl, hydrocarbyl, or substituted hydrocarbyl without specifying a particular isomer (such as butyl) expressly discloses all isomers (such as n-butyl, iso-butyl, sec-butyl, and tert-butyl). For example, reference to an R group having 4 carbon atoms expressly discloses all isomers thereof. When a compound is described herein such that a particular isomer, enantiomer or diastereomer of the compound is not specified, for example, in a formula or in a chemical name, that description is intended to include each isomer and enantiomer of the compound described individual or in any combination.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method. or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a filler” includes aspects comprising one, two, or more fillers, unless specified to the contrary or the context clearly indicates only one filler is included.

While the foregoing is directed to aspects of the present disclosure, other and further aspects of the disclosure may be devised without departing from the basic scope thereof, and the scope thereof is determined by the claims that follow.

What is claimed is:

1. A rotor of an electric motor, comprising:
a magnet; and
an epoxy resin composition disposed over the magnet, the epoxy resin composition comprising:
an epoxy resin;
a curing agent;
a first filler having a loose bulk density of greater than 0.5 g/cm³; and
a second filler having a loose bulk density of 0.5 g/cm³ or less, the second filler comprising a different filler than the first filler, and a total wt % of the first filler and the second filler that is from greater than 0 wt % to less than 50 wt % based on a total wt % of the epoxy resin composition, the total wt % of the epoxy resin composition being 100 wt %.

2. The rotor of claim 1, wherein the epoxy resin composition comprises:
from about 20 wt % to about 30 wt % of the epoxy resin based on the total wt % of the epoxy resin composition; and
from about 20 wt % to about 30 wt % of the curing agent based on the total wt % of the epoxy resin composition.

3. The rotor of claim 1, wherein the epoxy resin composition comprises:
from about 40 wt % to about 45 wt % of the first filler based on the total wt % of the epoxy resin composition;
from about 5 wt % to about 10 wt % of the second filler based on the total wt % of the epoxy resin composition; or
combinations thereof.

4. The rotor of claim 1, wherein the epoxy resin composition further comprises a polyhydric alcohol.

5. The rotor of claim 4, wherein the epoxy resin composition comprises from greater than 0 wt % to about 2 wt % or less of the polyhydric alcohol based on a total wt % of the epoxy resin composition.

6. The rotor of claim 1, wherein the first filler of the epoxy resin composition comprises perlite, quartz, fumed silica, fused silica, crystalline silica, alumina, kaolin, talc, clay, mica, rock wool, wollastonite, glass powder, glass flakes, glass beads, glass fibers, silicon carbide, silicon nitride, aluminum nitride, carbon black, graphite, titanium dioxide, calcium carbonate, calcium sulfate, barium carbonate, magnesium carbonate, magnesium sulfate, barium sulfate, epoxy-silane pre-treated silica, epoxy-silane pre-treated wollastonite, or combinations thereof.

7. The rotor of claim 1, wherein:
the second filler of the epoxy resin composition comprises perlite, silicon oxide, aluminium oxide, iron oxide, titanium dioxide, or combinations thereof; and
the loose bulk density of the second filler is less than about 0.2 g/cm³.

8. The rotor of claim 1, wherein:
an amount of the second filler in the epoxy resin composition is from greater than 0 wt % to about 10 wt % based on the total wt % of the epoxy resin composition;
a weight ratio of the first filler to the second filler is from about 4:1 to about 9:1; or
combinations thereof.

9. An article, comprising:
a metal substrate;
a material disposed on the metal substrate, the material comprising:
an epoxy resin composition comprising:
an epoxy resin;
a curing agent;
a first filler having a loose bulk density of greater than 0.5 g/cm³; and
a second filler having a loose bulk density of 0.5 g/cm³ or less, the second filler comprising a different filler than the first filler, and a total wt % of the first filler and the second filler that is from greater than 0 wt % to less than 50 wt % based on a total wt % of the epoxy resin composition, the total wt % of the epoxy resin composition being 100 wt %.

10. The article of claim 9, wherein the epoxy resin composition further comprises a polyhydric alcohol.

11. The article of claim 10, wherein the polyhydric alcohol is selected from the group consisting of ethylene glycol, propylene glycol, polyethylene glycol, polypropylene glycol, and combinations thereof.

12. The article of claim 9, wherein:
the material disposed on the metal substrate further comprises a sulfur-containing coupling agent disposed on the metal substrate; and
the epoxy resin composition is disposed on the sulfur-containing coupling agent.

13. The article of claim 12, wherein the sulfur-containing coupling agent comprises L-cysteine.

14. The article of claim 9, wherein the metal substrate comprises neodymium, neodymium alloy, neodymium iron boron, aluminum, aluminum alloy, nickel, iron, iron alloy, steel, electric steel, titanium, titanium alloy, copper, copper alloy, and mixtures thereof.

15. The article of claim 9, wherein the metal substrate comprises a component of an electric motor.

16. The article of claim 15, wherein the component of the electric motor comprises a rotor or a component thereof.

17. The article of claim 9, wherein the epoxy resin of the epoxy resin composition is derived from a compound selected from the group consisting of bisphenol A, bisphenol F, tetraglycidyl-methylenedianiline, a terephthalic acid, phthalic acid, hexahydrophthalic acid, halogenated bisphenol, novolac, ortho-aminophenol, para-aminophenol, flourenone bisphenol, dicyclopentadiene, and combinations thereof.

18. An epoxy resin composition, comprising:
an epoxy resin;
a curing agent;
a first filler having a loose bulk density of greater than 0.5 g/cm³; and
a second filler having a loose bulk density of 0.5 g/cm³ or less, the second filler comprising a different filler than the first filler, and a total wt % of the first filler and the second filler that is from greater than 0 wt % to less than 50 wt % based on a total wt % of the epoxy resin composition, the total wt % of the epoxy resin composition being 100 wt %.

19. The epoxy resin composition of claim 18, wherein the epoxy resin composition comprises:
from about 40 wt % to about 45 wt % of the first filler based on the total wt % of the epoxy resin composition; and
from about 5 wt % to about 10 wt % of the second filler based on the total wt % of the epoxy resin composition.

20. The epoxy resin composition of claim 18, wherein:
the first filler comprises perlite, quartz, fumed silica, fused silica, crystalline silica, alumina, kaolin, talc, clay, mica, rock wool, wollastonite, glass powder, glass flakes, glass beads, glass fibers, silicon carbide, silicon nitride, aluminum nitride, carbon black, graphite, titanium dioxide, calcium carbonate, calcium sulfate, barium carbonate, magnesium carbonate, magnesium sulfate, barium sulfate, or combinations thereof;
the second filler comprises perlite, silicon oxide, aluminium oxide, iron oxide, titanium dioxide, or combinations thereof;
the loose bulk density of the second filler is less than about 0.2 g/cm³; or
combinations thereof.
